(19) United States
(12) Patent Application Publication
(10) Pub. No.: US 2016/0315849 A1
(43) Pub. Date: Oct. 27, 2016

(54) INFORMATION PROCESSING APPARATUS, INFORMATION PROCESSING METHOD, AND COMPUTER READABLE MEDIUM

(71) Applicant: MITSUBISHI ELECTRIC CORPORATION, Tokyo (JP)

(72) Inventors: Shuto MURAI, Tokyo (JP); Toshihiro ICHIHARA, Tokyo (JP)

(73) Assignee: MITSUBISHI ELECTRIC CORPORATION, Tokyo (JP)

(21) Appl. No.: 15/101,324

(22) PCT Filed: Dec. 24, 2013
(86) PCT No.: PCT/JP2013/084498

§ 371 Date: Jun. 2, 2016

(51) Int. Cl. H04L 12/707; H04L 12/947; H04L 12/717; H04L 12/24

(52) U.S. Cl. CPC H04L 45/22; H04L 41/20; H04L 49/25; H04L 45/42

(57) ABSTRACT

An alternative route evaluation apparatus manages a network including a plurality of standard routes and a plurality of alternative routes. An alternative route is established for each standard route. Each standard route has, as constituent elements, two or more OFSes. Each alternative route has, as constituent elements, two or more OFSes, a combination of which being different from that of a corresponding standard route. In the alternative route evaluation apparatus, a priority order evaluating unit sets a priority level for each alternative route, based on the amount of relayed packets in the corresponding standard route. For each OFS, an alternative route registering unit selects a particular alternative route from among alternative routes having this OFS as a constituent element, based on the priority level set by the priority order evaluating unit.

### TECHNICAL FIELD

The present invention relates to a technology for managing a relay route for relaying a packet.

### BACKGROUND ART

Recently, SDN (Software Defined Networking) that manages a network in an integrated fashion by software (S/W) control is drawing attention as a concept for realizing network virtualization.

SDN is constituted by a centralized control apparatus called an SDN controller and a network device (SDN switch) supporting SDN.

By using SDN, the burden of work for changing a network can be reduced and a network suitable to needs can be easily constructed.

As a technology for implementing this SDN, an OpenFlow technology has been proposed.

OpenFlow treats a communication as an end-to-end flow and performs route control, failure recovery, load distribution, and optimization on a per-flow basis.

An OpenFlow switch (to be hereinafter referred to as an OFS) functioning as a forwarding node is provided with a secure channel for communication with an OpenFlow controller (to be hereinafter referred to as an OFC), and performs processing to forward a packet in accordance with a flow table, addition to which or rewriting of which is instructed by the OFC according to circumstances.

In a network using OpenFlow as described above, if a route failure or congestion occurs and switching of routes is required, the OFC generally reconstructs the topology, calculates routes, sets the flow table of each OFS, and issues an instruction for the switching of routes in each OFS.

Therefore, a problem is that if the switching of routes is required, the OFS needs to wait for a route switching instruction from the OFC and the switching of routes cannot be performed rapidly.

As to this problem, Patent Literature 1 discloses a method of registering an alternative route in advance, the alternative route being an alternative if a failure occurs in a standard route to be normally used.

The method of Patent Literature 1 allows each OFS to switch from the standard route to the alternative route without waiting for a route switching instruction from the OFC, upon occurrence of a route failure or congestion.

### CITATION LIST

### Patent Literature

Patent Literature 1: JP 2012-49674 A

### SUMMARY OF INVENTION

### Technical Problem

The conventional route switching method (Patent Literature 1) realizes rapid switching of routes by registering, in advance, an alternative route being an alternative to a standard route in the flow table of each OFS.

However, a problem is that, with an existing OFS, there is a limit to the number of routes that can be registered in a flow table, so that it is highly likely that registering both standard routes and alternative routes results in excess over the registration limit number of the flow table.

It may be possible to deal with this problem by adding an OFS, redesigning routes, and so on each time the number of registrations in the flow table approaches the limit number. However, this is not practical in terms of operation.

In view of the above-described circumstances, the present invention primarily aims to efficiently register alternative routes within limited storage resources of a relay device.

### Solution to Problem

An information processing apparatus according to the present invention manages a network including a plurality of standard routes and a plurality of alternative routes, the plurality of standard routes each being a relay route having, as constituent elements, two or more relay devices, the plurality of alternative routes each being established for a corresponding standard route and being a relay route having, as constituent elements, two or more relay devices, a combination of which being different from a combination of the relay devices of the corresponding standard route, and the information processing apparatus includes:
a priority level setting unit to set a priority level for each alternative route, based on an amount of relayed packets in the corresponding standard route; and
an alternative route selecting unit to select, for each relay device, a particular alternative route from among alternative routes having said each relay device as a constituent element, based on the priority level set by the priority level setting unit.

### Advantageous Effects of Invention

In the present invention, a priority level is set for each alternative route based on the amount of relayed packets in a standard route. For each relay device, a particular alternative route is selected based on the priority level from among alternative routes having this relay device as a constituent element.

Thus, an alternative route having a high priority level can be preferentially registered, allowing efficient registration of alternative routes within limited storage resources of the relay device.

### BRIEF DESCRIPTION OF DRAWINGS

FIG. 1 is a diagram illustrating an example of the configuration of an alternative route evaluation apparatus and an OFC according to a first embodiment;

FIG. 2 is a diagram illustrating an example of the configuration of an OFS according to the first embodiment;

FIG. 3 is a flowchart illustrating an example of the operation of the alternative route evaluation apparatus according to the first embodiment;

FIG. 4 is a diagram illustrating an example of a system configuration according to the first embodiment;

FIG. 5 is a diagram illustrating an example of definition information according to the first embodiment;

FIG. 6 is a diagram illustrating a procedure for transmitting statistics information according to the first embodiment;

FIG. 7 is a diagram illustrating an example of the statistics information according to the first embodiment;

FIG. 8 is a diagram illustrating an example of priority level information and an example of the statistics information on a per-flow-entry basis according to the first embodiment;

FIG. 9 is a diagram illustrating an example of the statistics information with priority levels added according to the first embodiment;

FIG. 10 is a diagram illustrating an example of a method for assessing the length of a registration period according to the first embodiment;

FIG. 11 is a diagram illustrating an example of the statistics information with a registration-period priority level added according to the first embodiment;

FIG. 12 is a diagram illustrating an example of a method for deriving a usage frequency according to the first embodiment;

FIG. 13 is a diagram illustrating an example of the statistics information according to the first embodiment;

FIG. 14 is a diagram illustrating an example of the statistics information with priority levels added and an example of the statistics information with a registration-period priority level added according to the first embodiment;

FIG. 15 is a diagram illustrating an example of usage frequency information according to the first embodiment;

FIG. 16 is a diagram illustrating an example of the priority level information of standard routes according to the first embodiment;

FIG. 17 is a diagram illustrating an example of calculating a sum of priority levels according to the first embodiment;

FIG. 18 is a diagram illustrating an example of a method for deriving a free capacity of the OFS according to the first embodiment;

FIG. 19 is a diagram illustrating an example of a method for selecting an alternative route according to the first embodiment;

FIG. 20 is a diagram illustrating an example of the method for selecting an alternative route according to the first embodiment; and

FIG. 21 is a diagram illustrating an example of the hardware configuration of the alternative route evaluation apparatus according to the first embodiment.

### DESCRIPTION OF EMBODIMENTS

### First Embodiment

This embodiment describes a configuration which realizes rapid switching of routes upon a failure while securing resources of a relay device (OFS) used in an SDN network, for example.

Specifically, this embodiment describes the configuration which evaluates a priority order of alternative routes based on usage frequencies of relay routes, and registers the alternative routes in descending order of priority levels, taking into consideration a free capacity of a flow table of each OFS.

With this configuration, rapid switching of routes upon a failure can be realized without causing depletion of the resources of the relay device.

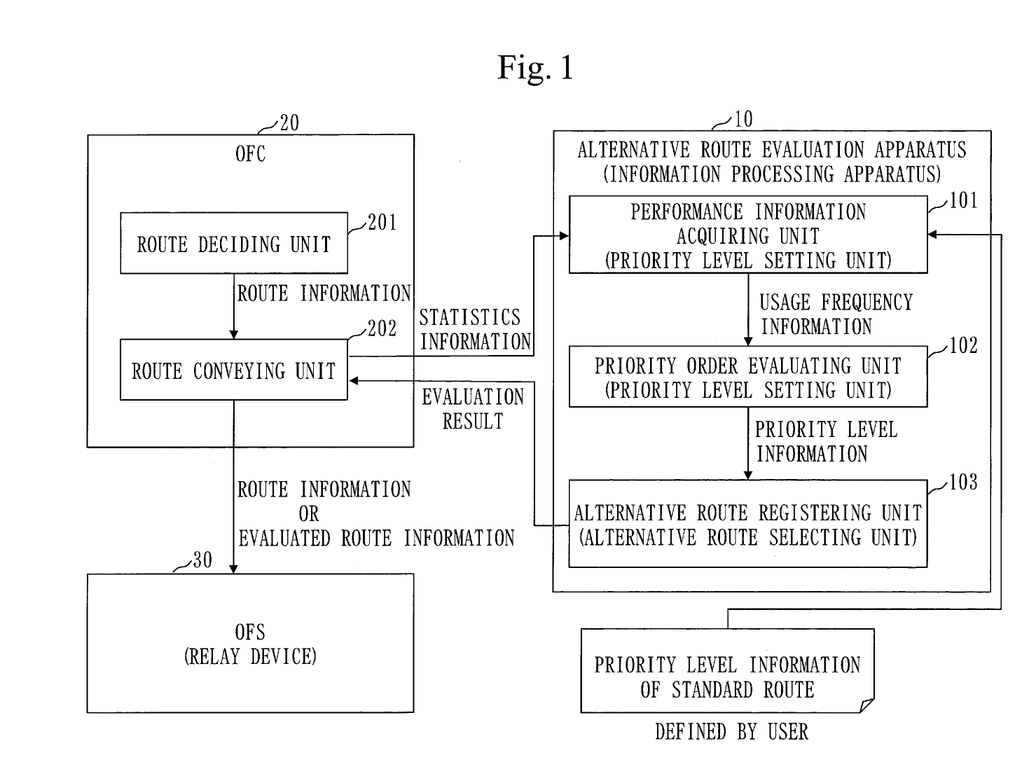

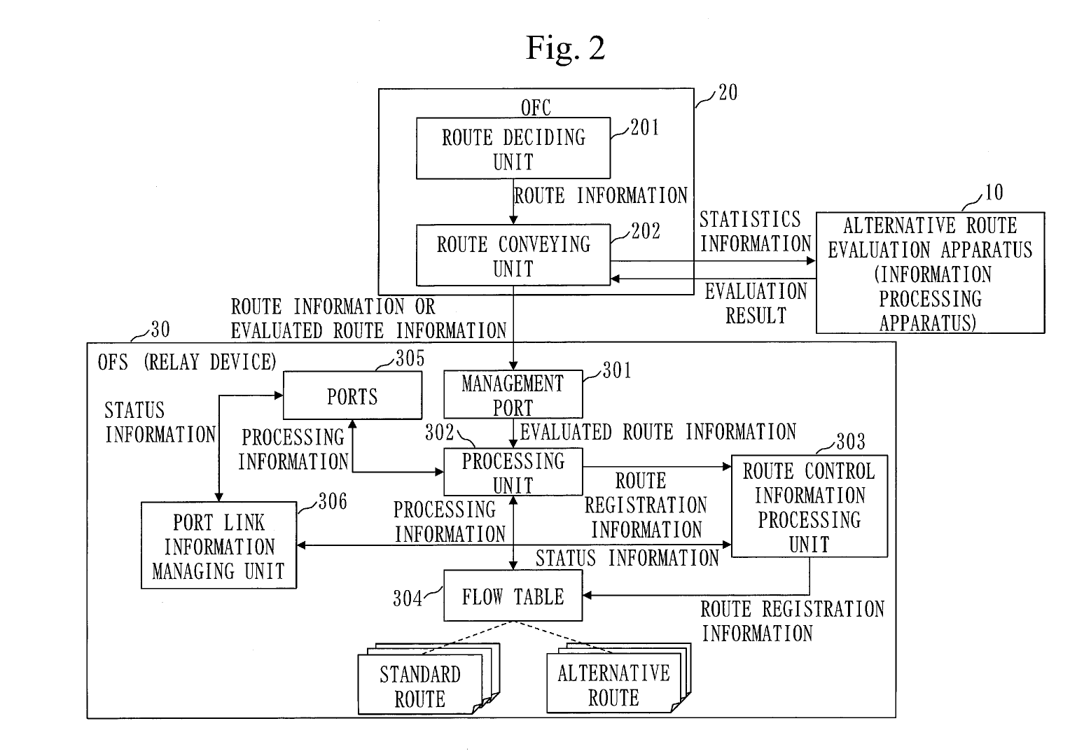

FIG. 1 and FIG. 2 illustrate an example of the configuration of a system including an alternative route evaluation apparatus 10 according to this embodiment.

FIG. 1 illustrates an example of the internal configuration of the alternative route evaluation apparatus 10 and an OFC 20, and FIG. 2 illustrates an example of the internal configuration of an OFS 30.

The alternative route evaluation apparatus 10 is an information processing apparatus that manages an SDN network including the OFC 20 being an SDN controller and the OFS 30 being an SDN switch.

In FIG. 1 and FIG. 2, only one OFS 30 is illustrated. It is assumed, however, that there exists a plurality of OFSes 30 in the SDN network.

As routes for relaying packets, the SDN network includes a plurality of standard routes and a plurality of alternative routes, the plurality of alternative routes each being established for a corresponding standard route and being an alternative to the corresponding standard route.

The standard routes are normally used for relaying packets, and the alternative routes are used when a failure occurs in the standard routes, and so on.

Each of the standard routes and the alternative routes includes two or more OFSes 30 as constituent elements and is configured by linking the two or more OFSes 30.

Note that a combination of the OFSes included in a standard route is different from a combination of the OFSes included in a corresponding alternative route.

In each OFS 30, a standard route is registered in a flow table 304.

An alternative route may also be registered in the flow table 304.

As will be described later, an alternative route selected by the alternative route evaluation apparatus 10 from among alternative routes not registered in the flow table 304 is newly registered in the flow table 304.

The alternative route evaluation apparatus 10 acquires route information generated by a route deciding unit 201 of the OFC 20 and statistics information of each OFS 30 acquired from each OFS 30 by a route conveying unit 202 of the OFC 20, and sets a priority level for each alternative route based on a usage frequency of a corresponding standard route.

The alternative route evaluation apparatus 10 also performs evaluation, taking into consideration the priority levels of alternative routes and a free capacity of the flow table of each OFS 30, and selects an alternative route to be registered in the flow table 304 of each OFS 30 from among the plurality of alternative routes.

In the alternative route evaluation apparatus 10, a performance information acquiring unit 101 acquires the statistics information of each OFS 30 from the route conveying unit 202 of the OFC 20, and derives a usage frequency (amount of relayed packets per unit time) of a standard route from the acquired statistics information.

Then, the performance information acquiring unit 101 outputs usage frequency information indicating the derived usage frequency to a priority order evaluating unit 102.

The statistics information exists for each route (standard route, alternative route) registered in the flow table 304 of each OFS 30.

The statistics information describes a reference count (amount of relayed packets) of the route, an elapsed time from when the route is registered, the number of registered routes, and so on.

The performance information acquiring unit 101 also acquires priority level information, defined by a user, of a standard route.

The performance information acquiring unit 101 together with the priority order evaluating unit 102 to be described later correspond to an example of a priority level setting unit.

The priority order evaluating unit 102 sets a priority level for each alternative route based on the usage frequency information from the performance information acquiring unit 101.

Then, the priority order evaluating unit 102 outputs priority level information indicating the priority level of each alternative route to an alternative route registering unit 103.

The priority order evaluating unit 102 together with the performance information acquiring unit 101 described above correspond to an example of the priority level setting unit.

The alternative route registering unit 103 derives a free capacity (storage capacity) of the flow table 304 of each OFS 30 from the statistics information acquired by the performance information acquiring unit 101.

Then, the alternative route registering unit 103 decides on an alternative route to be registered in the flow table 304, taking into consideration the derived free capacity and the priority level information provided by the priority order evaluating unit 102.

Then, the alternative route registering unit 103 notifies the route conveying unit 202 of the OFC 20 of the decided alternative route as an evaluation result.

The alternative route registering unit 103 corresponds to an example of an alternative route selecting unit.

In the OFC 20, the route deciding unit 201 generates route information indicating standard routes and alternative routes in response to an inquiry from each OFS 30.

Then, the route deciding unit 201 delivers the generated route information to each OFS 30 through the route conveying unit 202.

The route conveying unit 202 delivers the route information provided by the route deciding unit 201 to each OFS 30.

The route conveying unit 202 also transmits the statistics information acquired from each OFS 30 to the performance information acquiring unit 101.

The route conveying unit 202 also acquires the evaluation result from the alternative route registering unit 103, generates evaluated route information indicating the alternative route selected by the alternative route registering unit 103, and delivers the generated evaluated route information to each OFS 30.

In the OFS 30, a management port 301 is a port which is different from ports 305 for communication.

The management port 301 is a port for connection with the OFC 20.

The management port 301 outputs the route information or the evaluated route information provided by the route conveying unit 202 to a processing unit 302.

The processing unit 302 acquires the route information or the evaluated route information from the management port 301, and if it is determined that the content of the route information or the evaluated route information needs to be registered in the flow table 304, outputs the route information or the evaluated route information as route registration information to a route control information processing unit 303.

On the other hand, if registration is not required, the processing unit 302 refers to the flow table 304 to obtain the OFS 30 to which the route information or the evaluated route information is to be provided, and outputs the route information or the evaluated route information as processing information to the ports 305.

Then, the route information or the evaluated route information is delivered from the ports 305 to the OFS 30 to which the route information or the evaluated route information is to be provided.

The processing unit 302 also refers to the flow table 304 and makes an inquiry to the OFC 20 in accordance with processing information provided from the ports 305.

The route control information processing unit 303 registers the content of the route registration information provided by the processing unit 302 in the flow table 304.

The route control information processing unit 303 also determines whether or not it is necessary to use the alternative route based on status information provided by a port link information managing unit 306.

Then, if it is necessary to use the alternative route, the route control information processing unit 303 updates the flow table 304 so as to allow the alternative route to be used.

In the flow table 304, a route setting is registered based on the route registration information provided by the route control information processing unit 303.

The route setting defines, for each route (standard route, alternative route), a combination of a rule to be matched against a packet header, an action defining the content of processing, and flow statistics information.

The ports 305 are a set of ports used for communication with other OFSes 30.

The ports 305 deliver processing information from the processing unit 302 to the other OFSes 30.

The ports 305 also output processing information (route information or evaluated route information) provided by the other OFSes 30 to the processing unit 302.

The port link information managing unit 306 manages link status of the ports 305.

The port link information managing unit 306 detects the link status of the ports at fixed intervals by polling or the like, and if a failure or the like occurs in the ports, outputs status information for notifying the link status to the route control information processing unit 303.

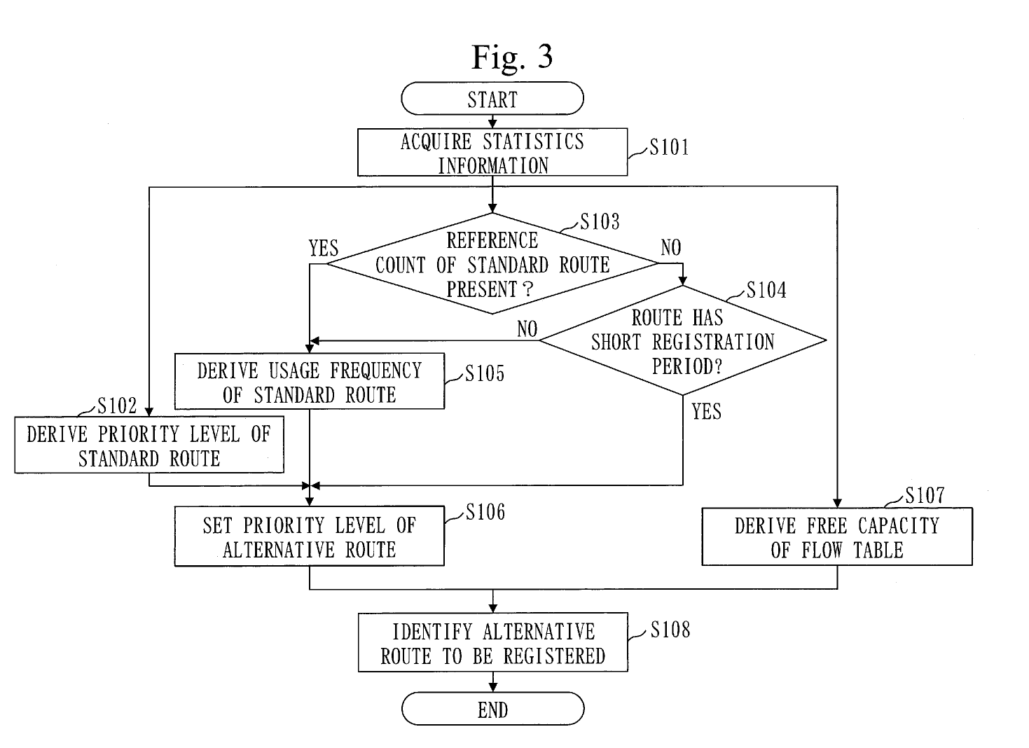

With reference to FIG. 3, an example of the operation of the alternative route evaluation apparatus 10 according to this embodiment will now be described.

First, in S101, the performance information acquiring unit 101 acquires the statistics information of each OFS 30 from the OFC 20.

After the statistics information is acquired, processing in S102, processing in S103, and processing in S107 are performed.

It is assumed that the statistics information can be acquired at any time.

In S102, the performance information acquiring unit 101 derives a priority level of a standard route based on the statistics information acquired in S101 and the priority level information defined by the user.

After the priority level of the standard route is derived, processing in S106 is performed.

In S103, the performance information acquiring unit 101 checks if a reference count is present for a standard route in the statistics information acquired in S101.

In the statistics information, the number of packets relayed in the standard route (amount of relayed packets) is described as the reference count.

If the reference count is present, that is, if the reference count described in the statistics information is 1 or more, then processing in S105 is performed.

On the other hand, if the reference count is not present, that is, the reference count described in the statistics information is 0, then processing in S104 is performed.

In S104, the performance information acquiring unit 101 checks the length of a period from when the standard route for which the non-presence of a reference count is determined in S103 is registered in the flow table (registration period).

The registration period corresponds to an elapsed time from when the standard route becomes valid in the SDN network.

A threshold value to be used for determining whether the registration period is long or short is set by the user in advance.

If the registration period is larger than the threshold value, the performance information acquiring unit 101 determines that the standard route has not been referenced for a long period of time.

Then, processing in S105 is performed.

On the other hand, if the registration period is equal to or smaller than the threshold value, the performance information acquiring unit 101 determines that the standard route has never been referenced, on account of the shortness of the registration period.

The performance information acquiring unit 101 sets an additional priority level to this standard route.

Then, processing in S106 is performed.

Note that the additional priority level is set by the user in advance.

In S105, the performance information acquiring unit 101 derives a usage frequency of the standard route for which the presence of a reference count is determined in S103 and a usage frequency of the standard route determined in S104 as not being referenced for a long period of time.

After the usage frequencies are derived, processing in S106 is performed.

In S106, the priority order evaluating unit 102 sets a priority level for each alternative route based on the priority level of the standard route derived in S102, the additional priority level, set in S104, of the standard route having a short registration period, and the usage frequency of the standard route derived in S105.

After the priority levels are set, processing in S108 is performed.

In S107, the alternative route registering unit 103 derives a free capacity for registration in each OFS 30 based on the statistics information acquired in S101 and a total registration amount defined by the user.

After the free capacity is derived, processing in S108 is performed.

In S108, the alternative route registering unit 103 identifies an alternative route to be registered in the flow table in each OFS 30 based on the priority levels of the alternative routes set in S106 and the free capacity of the flow table derived in S107.

Then, the alternative route registering unit 103 transmits to the OFC 20 an evaluation result indicating the alternative route to be registered.

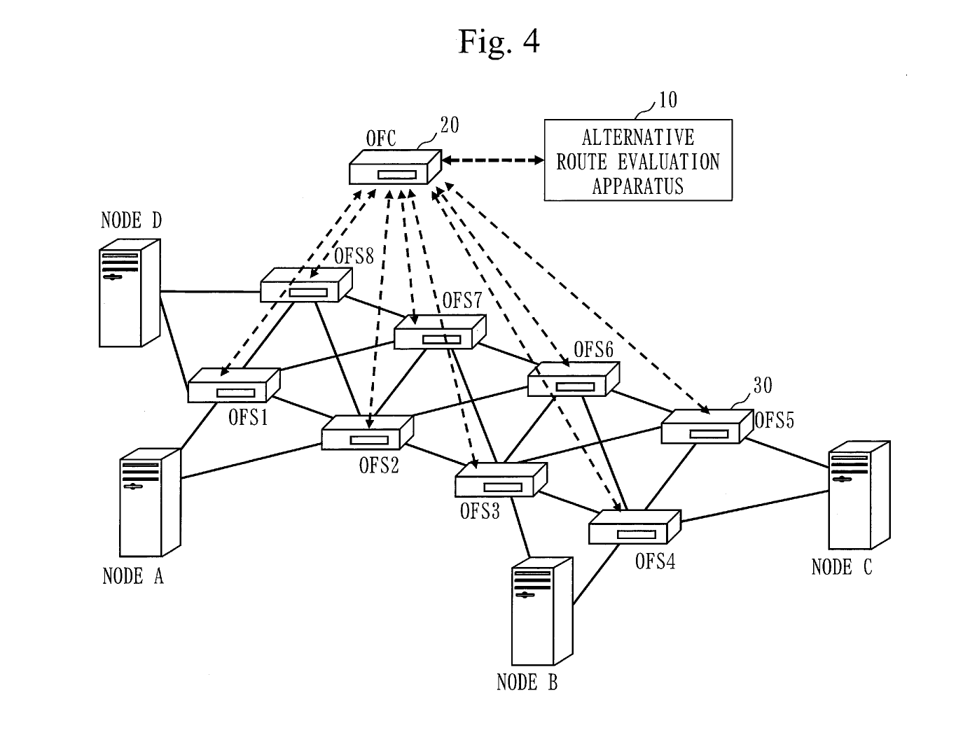

With reference to FIG. 4 to FIG. 20, each step illustrated in FIG. 3 will now be described in detail.

The following description will be based on an example of a system configuration illustrated in FIG. 4.

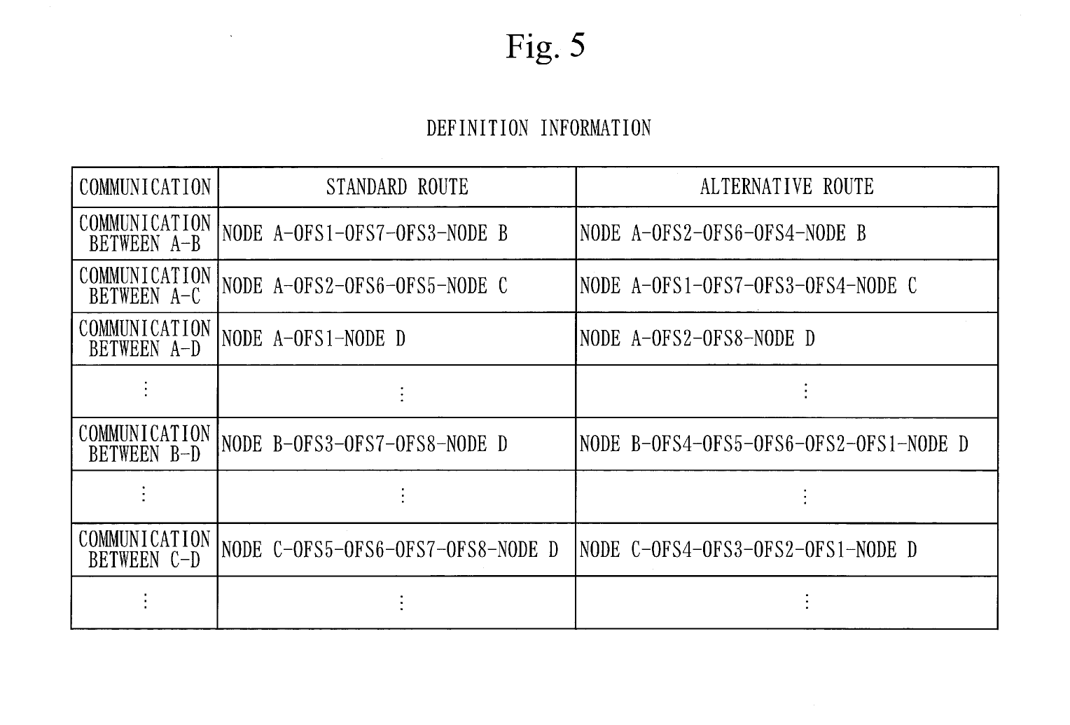

It is also assumed that the route deciding unit 201 of the OFC 20 holds definition information illustrated in FIG. 5.

Note that the format of the definition information may be different from the format illustrated in FIG. 5.

In the example of the system configuration of FIG. 4, a standard route being Node A-OFS1-OFS7-OFS3-Node B is normally used for relaying a packet between Node A and Node B, and if a failure or the like occurs in this standard route, an alternative route being Node A-OFS2-OFS6-OFS4-Node B is used, as indicated in FIG. 5.

As indicated in FIG. 5, a combination of the OFSes included in a standard route is different from a combination of the OFSes included in a corresponding alternative route.

In S101 of FIG. 3, the performance information acquiring unit 101 acquires the statistics information of each OFS 30 from the OFC 20.

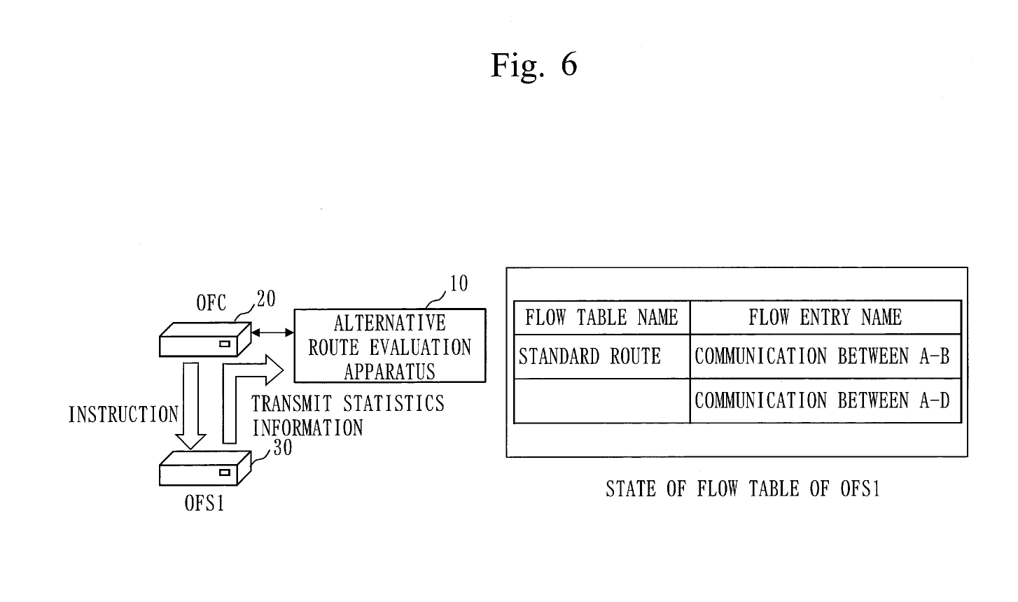

As illustrated in FIG. 6, the OFC 20 instructs each OFS 30 to transmit the statistics information, and each OFS 30 transmits the statistics information to the OFC 20.

Then, upon receiving the statistics information, the OFC 20 transmits the statistics information to the alternative route evaluation apparatus 10.

In the OpenFlow specifications, the statistics information can be acquired on a per-flow-table basis or on a per-flow-entry basis.

The statistics information on a per-flow-table basis is composed of a flow table name and the number of valid entries representing the number of registered routes.

The statistics information on a per-flow-entry basis is composed of an OFS name, a flow table name, a flow entry name, the number of received packets representing a reference count, and a duration representing the time from registration to the present.

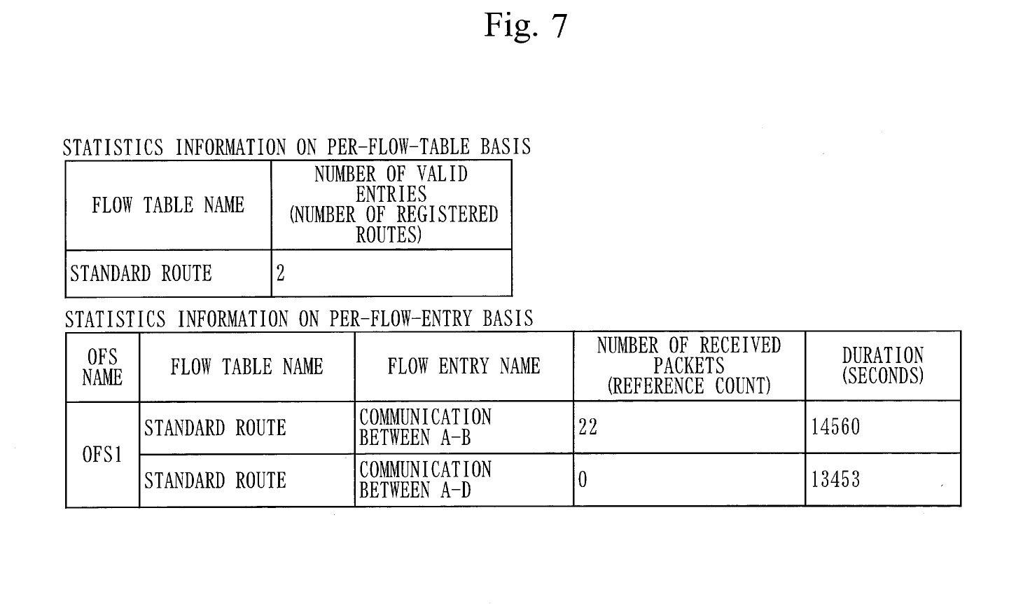

FIG. 7 illustrates an example of the statistics information on a per-flow-table basis and an example of the statistics information on a per-flow-entry basis in a case where the flow table of OFS1 is in a state as illustrated in FIG. 6.

In S102, the performance information acquiring unit 101 derives a priority level of a standard route based on the statistics information acquired in S101 and the priority level information defined by the user.

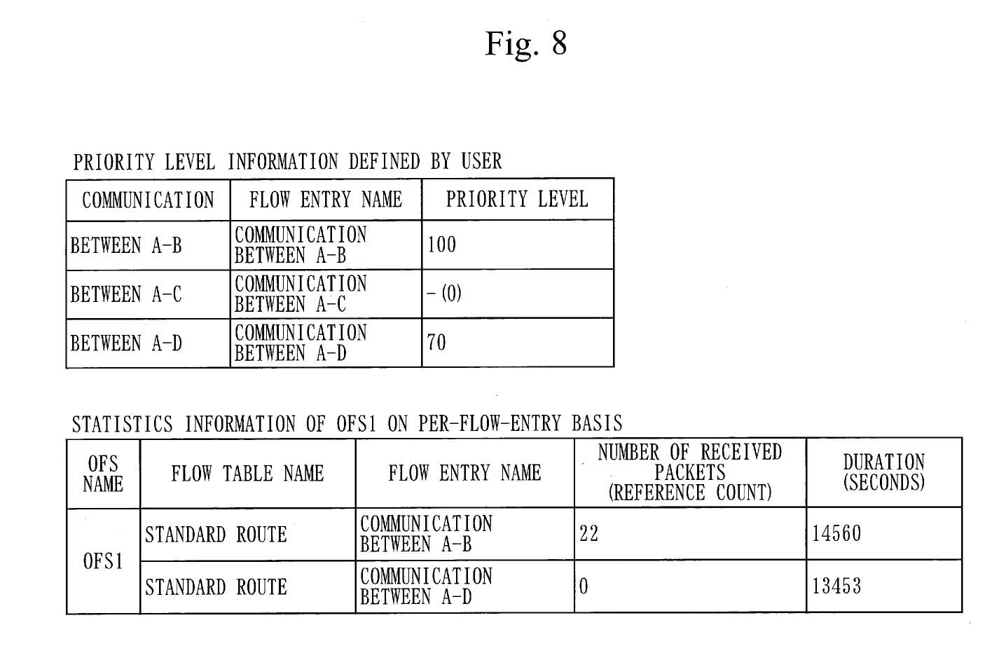

FIG. 8 illustrates an example of the statistics information on a per-flow-entry basis and an example of the priority level information.

The priority level information defined by the user is composed of a communication, a corresponding flow entry name, and a priority level.

A larger value represents a higher priority level.

A flow entry for which a priority level is not defined has a priority level of 0.

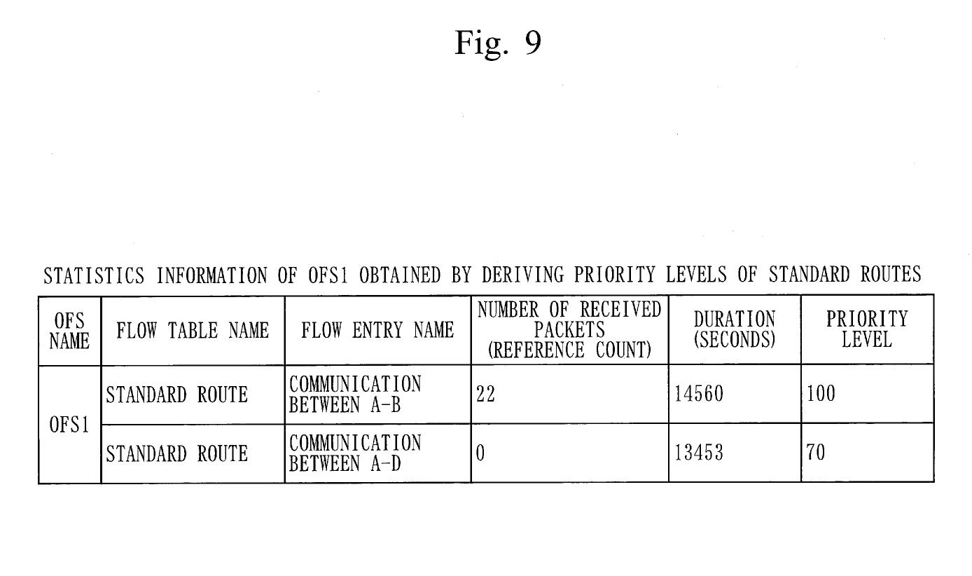

FIG. 9 illustrates an example of the statistics information on a per-flow-entry basis with priority levels added.

In S103, the performance information acquiring unit 101 checks if a reference count is present for a standard route in the statistics information acquired in S101.

In the statistics information of FIG. 9, a reference count is present for a communication between A-B, and a reference count is not present for a communication between A-D.

In the case of the statistics information of FIG. 9, processing moves to S105 with regard to the standard route for the communication between A-B of OFS1, and processing moves to S104 with regard to the standard route for the communication between A-D of OFS1.

In S104, the performance information acquiring unit 101 checks the length of a period from when the standard route for which the non-presence of a reference count is determined in S103 is registered in the flow table (registration period).

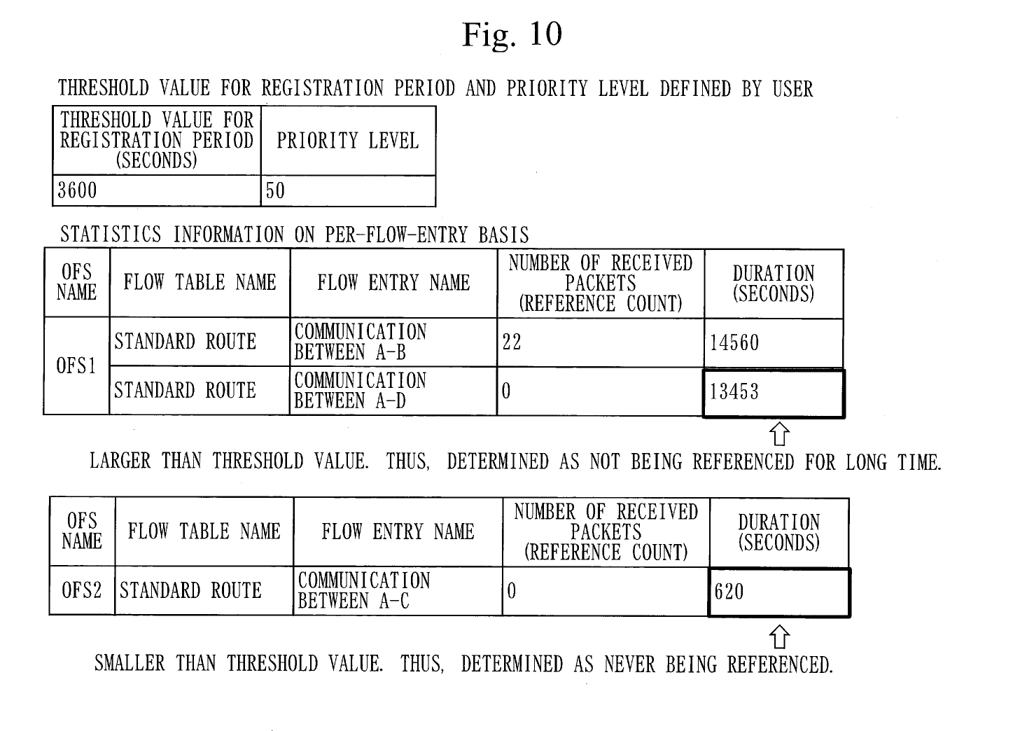

FIG. 10 explains the details of processing in S104.

In an example of FIG. 10, it is assumed that the threshold value for the registration period is 3600 seconds.

It is also assumed that the additional priority level is 50.

The duration of the communication between A-D indicated in the statistics information of OFS1 is 13453 seconds, and the registration period (duration) is longer than the threshold value. Thus, the performance information acquiring unit 101 determines that the standard route for the communication between A-D has not been referenced for a long period of time.

On the other hand, the duration of a communication between A-C indicated in the statistics information of OFS2 is 620 seconds, and the registration period (duration) is shorter than the threshold value. Thus, the performance information acquiring unit 101 determines that the standard route for the communication between A-C has never been referenced, on account of the shortness of the registration period.

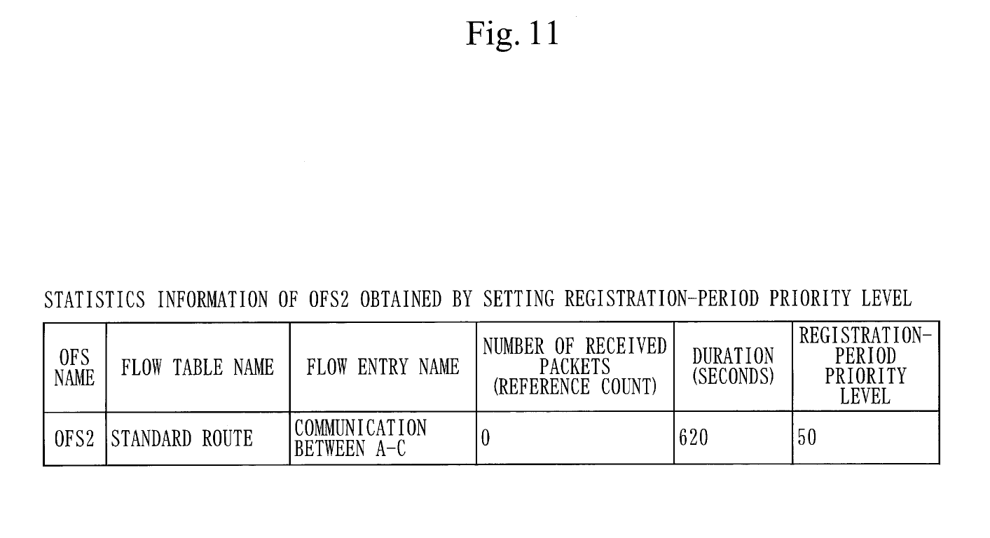

Then, as illustrated in FIG. 11, the performance information acquiring unit 101 adds the additional priority level (registration-period priority level) to the statistics information of OFS2.

In S105, the performance information acquiring unit 101 derives a usage frequency of the standard route for which the presence of a reference count is determined in S103 and a usage frequency of the standard route determined in S104 as not being referenced for a long period of time.

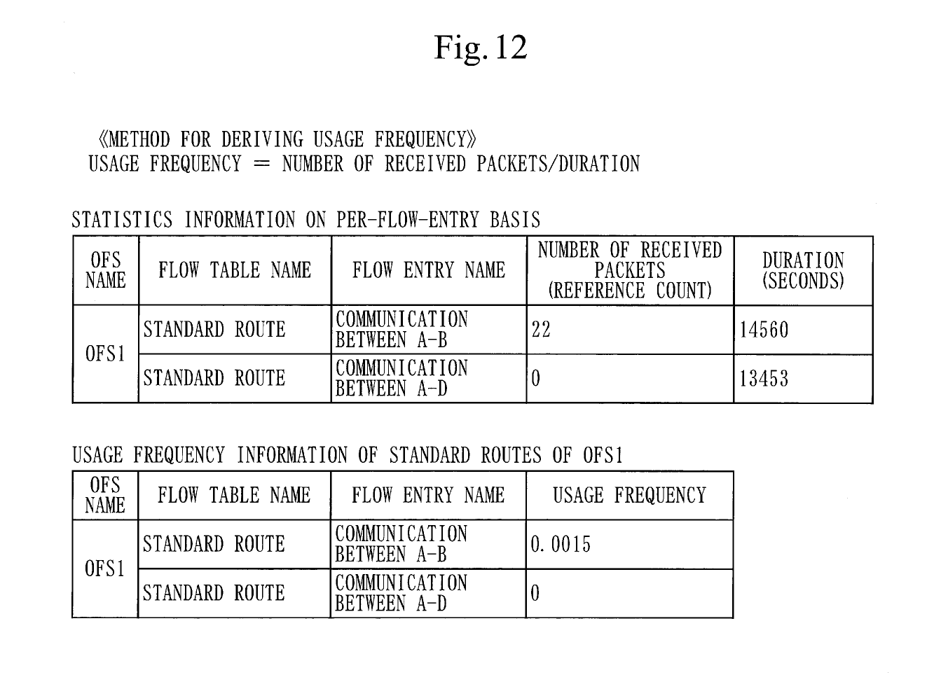

FIG. 12 illustrates an example of deriving the usage frequency in S105.

The usage frequency is the number of received packets per second, and is derived by “the number of received packets/duration”.

For example, for the standard route for the communication between A-B, the performance information acquiring unit 101 derives 22/14560=0.0015 as the usage frequency, and generates usage frequency information describing the derived usage frequency.

In S106, the priority order evaluating unit 102 sets a priority level for each alternative route based on the priority level of the standard route derived in S102, the additional priority level, set in S104, of the standard route having a short registration period, and the usage frequency of the standard route derived in S105.

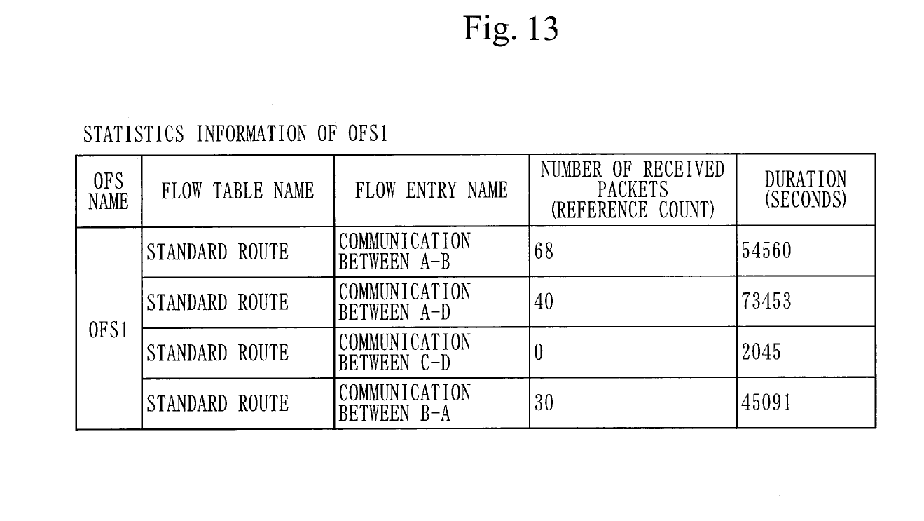

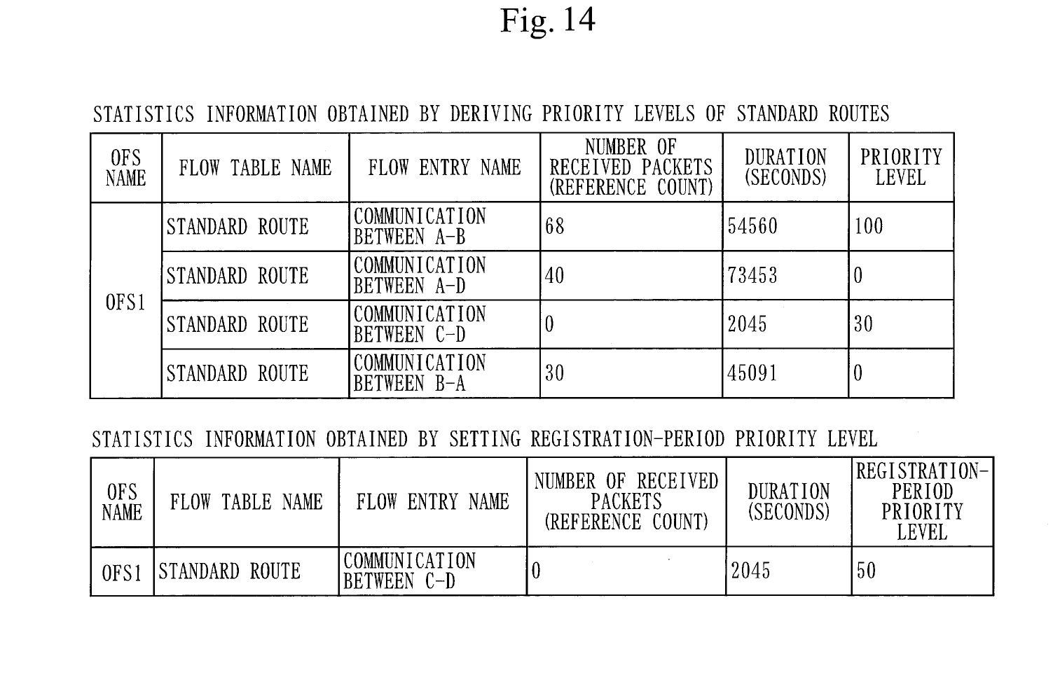

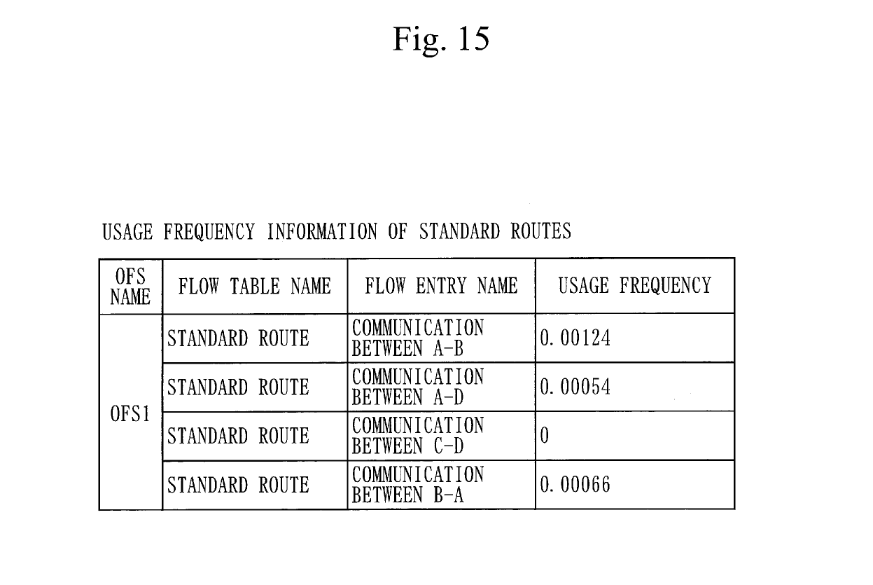

It is assumed here, for example, that the statistics information of OFS1 acquired in S101 is as illustrated in FIG. 13, the statistics information of OFS1 with the priority levels added and the statistics information of OFS1 with the additional priority level added are as illustrated in FIG. 14, and the usage frequency information of OFS1 is as illustrated in FIG. 15.

The priority order evaluating unit 102 adds the priority level and the additional priority level of FIG. 14 and the usage frequency of FIG. 15 together to obtain a total priority level of each standard route in OFS1.

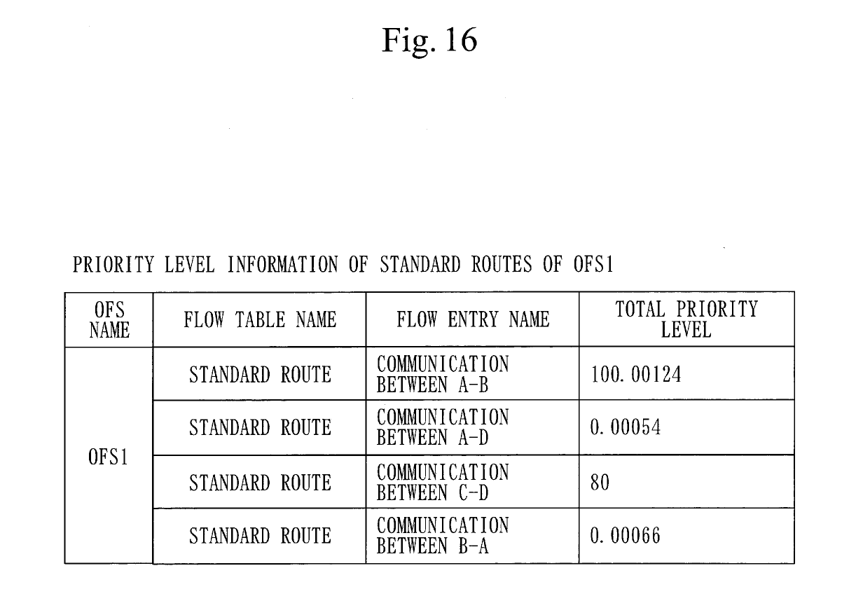

FIG. 16 illustrates the total priority level of each standard route of OFS1.

Then, the priority order evaluating unit 102 calculates a sum of the total priority levels of individual OFSes with regard to each standard route, and treats the value of the sum as the priority level of a corresponding alternative route.

For example, the standard route between A-B has OFS1, OFS7, and OFS3 as constituent elements (FIG. 5).

The priority order evaluating unit 102 calculates a sum of the total priority level of OFS1, the total priority level of OFS7, and the total priority level of OFS3 with regard to the standard route between A-B of OFS1, and treats the value of the sum as the priority level of the alternative route between A-B.

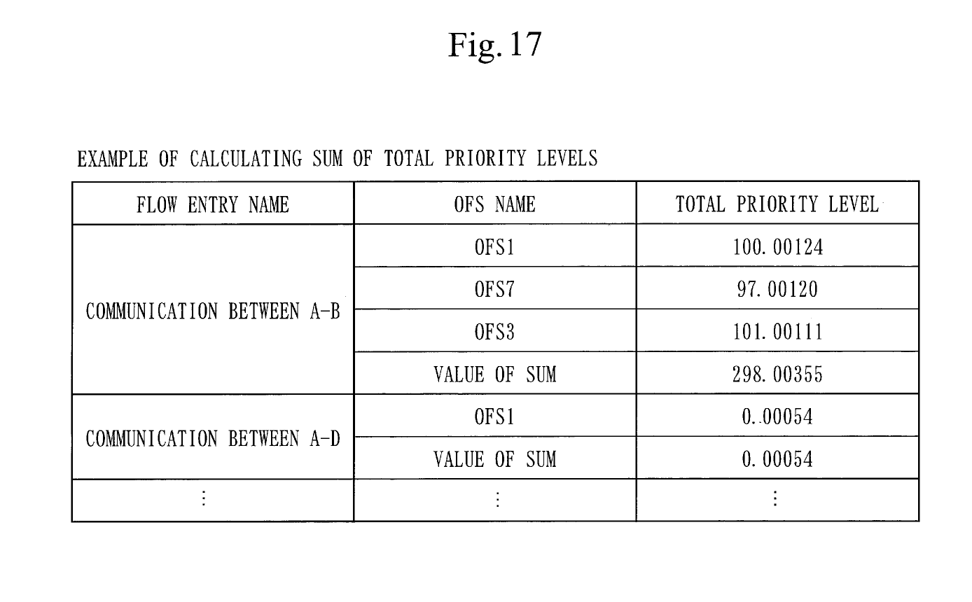

In an example of FIG. 17, the total priority level of the standard route between A-B of OFS1 is “100.00124”.

The total priority level of the standard route between A-B of OFS7 is “97.00120”.

The total priority level of the standard route between A-B of OFS3 is “101.00111”.

The priority order evaluating unit 102 calculates a sum of the total priority levels of these three OFSes, and treats the value of the sum “298.00355” as the priority level of the alternative route between A-B.

The priority order evaluating unit 102 similarly performs processing to calculate a sum for each alternative route, and calculates a priority level of each alternative route.

In S107, the alternative route registering unit 103 derives a free capacity for registration in each OFS 30 based on the statistics information acquired in S101 and the total registration amount defined by the user.

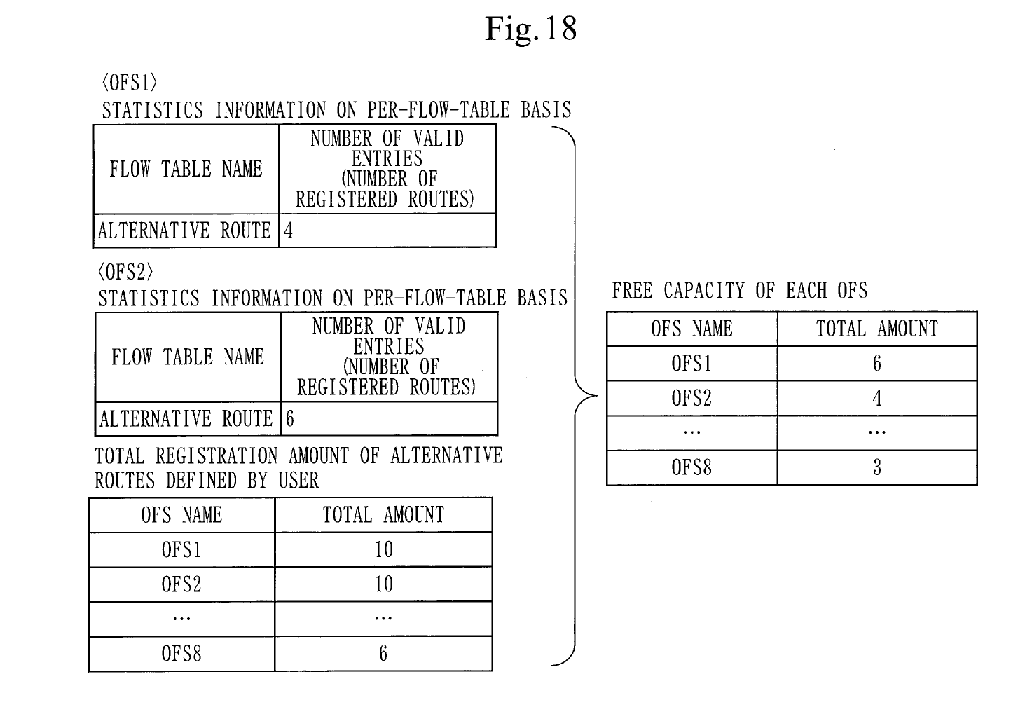

FIG. 18 illustrates an example of deriving the free capacity of each OFS 30.

Assuming that the user sets 10 as the total amount of the flow table for alternative routes (the number of allowed registrations of alternative routes) of OFS1, if four alternative routes have already been registered in the flow table of OFS1, there are six vacancies and the free capacity is 6.

That is, the number of alternative routes to be selected by the alternative route registering unit 103 is 6.

Then, in S108, the alternative route registering unit 103 identifies an alternative route to be registered in the flow table in the OFS 30 based on the priority levels of the alternative routes set in S106 and the free capacity of the flow table derived in S107.

In S108, the alternative route registering unit 103 selects, for each OFS 30, alternative routes to be registered in descending order of the priority levels within the free capacity, from among the alternative routes including this OFS 30 as a constituent element.

As indicated in the definition information of FIG. 5, OFS2 is included in the alternative route for the communication between A-B, the alternative route for the communication between A-D, the alternative route for a communication between B-D, the alternative route for a communication between C-D, and so on.

The free capacity of OFS2 is 4.

Therefore, with regard to OFS2, the alternative route registering unit 103 selects four alternative routes to be registered in descending order of the priority levels, from among the alternative route for the communication between A-B, the alternative route for the communication between A-D, the alternative route for the communication between B-D, the alternative route for the communication between C-D, and so on.

If the free capacity is equal to the number of alternative routes, or if the number of alternative routes is smaller than the free capacity, all of the alternative routes are selected.

On the other hand, if the number of alternative routes is larger than the free capacity, not all of the alternative routes can be registered.

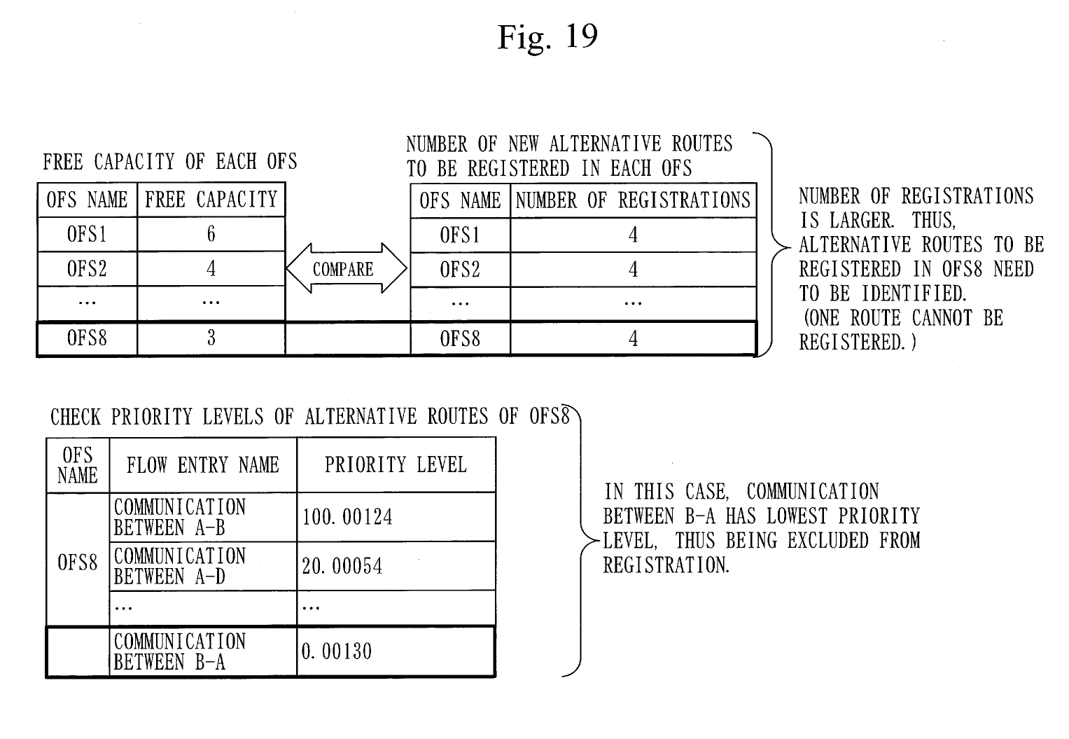

FIG. 19 illustrates an example where the free capacity of OFS8 is 3 and there are four alternative routes including OFS8 as a constituent element, so that the alternative route for a communication between B-A having the lowest priority level is not registered in the flow table.

There are two reasons for occurrence of a case where the number of alternative routes is larger than the free capacity as follows:

(1) Reduction in the total registration amount, defined by the user, of the flow table for alternative routes

There may be a case where the user reduces the total registration amount of the flow table for alternative routes in order to increase the number of registrations in the flow table for standard routes.

In this case, the number of alternative routes becomes larger than the free capacity.

(2) Addition of an alternative route due to registration of a new standard route

Registration of a new standard route causes registration of an alternative route corresponding to this standard route.

In this case, if a result of adding the number of alternative routes newly registered and the number of alternative routes already registered exceeds the free capacity, the number of alternative routes becomes larger than the free capacity.

In S108, the alternative route registering unit 103 does not select an alternative route which it has not selected for one of the OFSes also for the other OFSes.

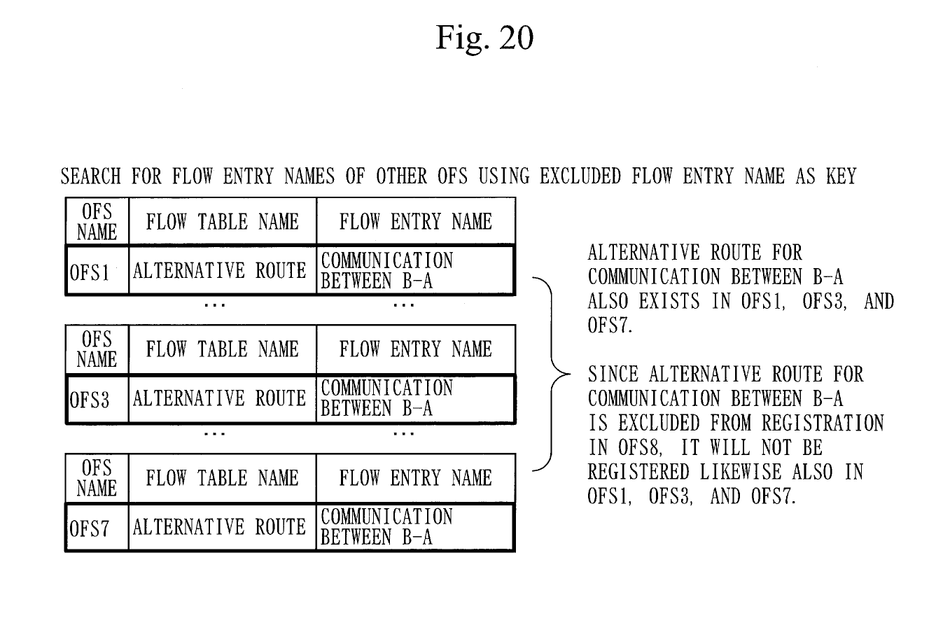

FIG. 20 illustrates that the alternative route for the communication between B-A which is excluded from registration in OFS8 will also be excluded from registration in OFS1, OFS3, and OFS7.

As described above, this embodiment evaluates the priority order of the alternative routes based on the usage frequencies of the standard routes, and registers the alternative routes in descending order of the priority levels, taking into consideration the free capacity of the flow table of each OFS. Thus, rapid switching of routes upon a failure can be realized without causing depletion of the resources of each OFS.

The above description has been provided using the SDN network as an example. However, the network to which the alternative route evaluation apparatus 10 is applied is not limited to the SDN network.

In the above, it has been described that in S106 of FIG. 3, the alternative route registering unit 103 calculates a sum of the total priority levels of a plurality of OFSes included in a standard route and treats the value of the sum as the priority level of a corresponding alternative route (FIG. 17). If the OFSes included in the standard route have a common total priority level, the total priority level of one of the OFSes may be directly used as the priority level of the corresponding alternative route.

That is, if OFS1, OFS7, and OFS3 included in the standard route for the communication between A-B have a common usage frequency, a common priority level, and a common registration period and thus OFS1, OFS7, and OFS3 also have a common total priority level, the total priority level of OFS1, for example, may be directly used as the priority level of the alternative route for the communication between A-B without calculating a sum of the total priority levels of OFS1, OFS7, and OFS3 as in FIG. 17.

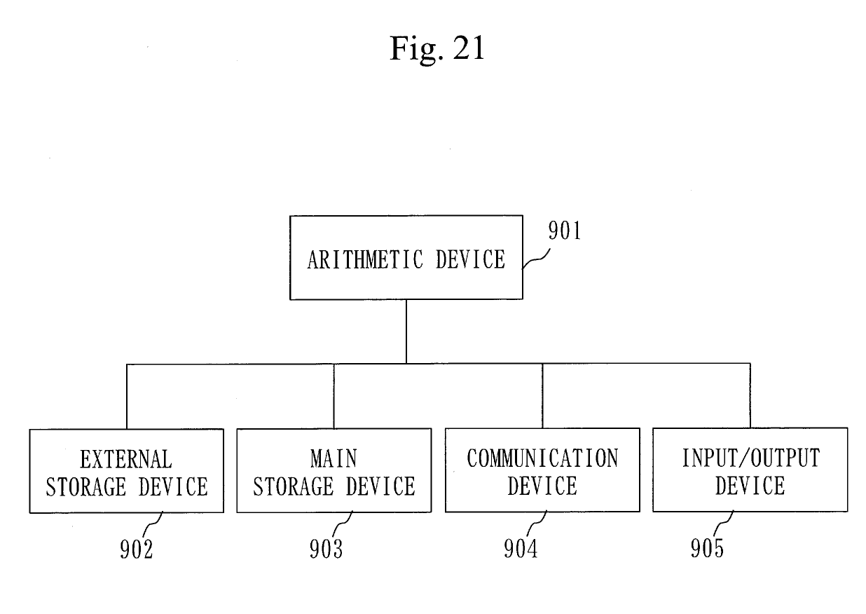

Lastly, with reference to FIG. 21, an example of the hardware configuration of the alternative route evaluation apparatus 10 presented in this embodiment will be described.

The alternative route evaluation apparatus 10 is a computer, and each element of the alternative route evaluation apparatus 10 can be implemented by a program.

As the hardware configuration of the alternative route evaluation apparatus 10, an arithmetic device 901, an external storage device 902, a main storage device 903, a communication device 904, and an input/output device 905 are connected to a bus.

The arithmetic device 901 is a CPU (Central Processing Unit) that executes programs.

The external storage device 902 is, for example, a ROM (Read Only Memory), a flash memory, and a hard disk device.

The main storage device 903 is a RAM (Random Access Memory).

The communication device 904 is, for example, a NIC (Network Interface Card).

The input/output device 905 is, for example, a mouse, a keyboard, a display device, and the like.

The programs are normally stored in the external storage device 902 and are loaded into the main storage device 903 to be sequentially read and executed by the arithmetic device 901.

The programs are programs for implementing the functions described as “units” illustrated in FIG. 1.

Further, an operating system (OS) is also stored in the external storage device 902, and at least part of the OS is loaded into the main storage device 903. The arithmetic device 901 executes the programs for implementing the functions of the “units” illustrated in FIG. 1 while executing the OS.

Information, data, signal values, and variable values indicating results of processing described as “determine”, “assess”, “extract”, “select”, “decide”, “identify”, “calculate”, “compute”, “derive”, “set”, “register”, “generate”, “acquire”, “output”, and so on in the description of this embodiment are stored as files in the main storage device 903.

Note that the configuration of FIG. 21 is an example of the hardware configuration of the alternative route evaluation apparatus 10, and the hardware configuration of the alternative route evaluation apparatus 10 is not limited to and may be different from the configuration described in FIG. 21.

The OFC 20 and the OFS 30 presented in this embodiment may have the hardware configuration of FIG. 21, and may also have a different hardware configuration.

An information processing method according to the present invention can be implemented by the procedures presented in this embodiment.

### REFERENCE SIGNS LIST

10: alternative route evaluation apparatus, 20: OFC, 30: OFS, 101: performance information acquiring unit, 102: priority order evaluating unit, 103: alternative route registering unit, 201: route deciding unit, 202: route conveying unit, 301: management port, 302: processing unit, 303: route control information processing unit, 304: flow table, 305: ports, 306: port link information managing unit

1-10. (canceled)

11. An information processing apparatus to manage a network including a plurality of standard routes and a plurality of alternative routes, the plurality of standard routes each being a relay route having, as constituent elements, two or more relay devices, the plurality of alternative routes each being established for a corresponding standard route and being a relay route having, as constituent elements, two or more relay devices, a combination of which being different from a combination of the relay devices of the corresponding standard route, the information processing apparatus comprising:
processing circuitry to:
analyze, for each alternative route, an amount of relayed packets per unit time in the corresponding standard route, perform a computation for each standard route using a priority level which is specified in advance for each standard route and an amount of relayed packets per unit time in each standard route, set a priority level for each alternative route, based on the result of the computation of the corresponding standard route, and
select, for each relay device, a particular alternative route from among alternative routes having said each relay device as a constituent element, based on the priority level which has been set.

12. The information processing apparatus according to claim 11,
wherein the processing circuitry derives, for each relay device, a selection number of alternative routes, based on a storage capacity of said each relay device, and selects, for said each relay device, a number of alternative routes equal to the selection number, based on the priority level which has been set.

13. The information processing apparatus according to claim 11,
wherein the processing circuitry sets the priority level for each alternative route, such that an alternative route whose corresponding standard route has a larger value of the result of the computation is given a higher priority level.

14. The information processing apparatus according to claim 11,
wherein the processing circuitry performs the computation, with regard to a standard route whose amount of relayed packets per unit time is less than a threshold value and whose elapsed time from when becoming valid in the network is less than a threshold time, using a priority level which is specified in advance for said standard route, an amount of relayed packets per unit time in said standard route, and an additional priority level.

15. The information processing apparatus according to claim 11,
wherein the processing circuitry does not select an alternative route which has not been selected for one of the relay devices also for any of the relay devices.

16. The information processing apparatus according to claim 11,
the information processing apparatus managing an SDN network including SDN (Software Defined Networking) switches as the relay devices,
wherein the processing circuitry selects, for each SDN switch, a particular alternative route from among alternative routes having said each SDN switch as a constituent element, based on the priority level which has been set.

17. An information processing method for managing a network including a plurality of standard routes and a plurality of alternative routes, the plurality of standard routes each being a relay route having, as constituent elements, two or more relay devices, the plurality of alternative routes each being established for a corresponding standard route and being a relay route having, as constituent elements, two or more relay devices, a combination of which being different from a combination of the relay devices of the corresponding standard route, the information processing method comprising:
analyzing, for each alternative route, an amount of relayed packets per unit time in the corresponding standard route, performing a computation for each standard route using a priority level which is specified in advance for each standard route and an amount of relayed packets per unit time in each standard route, and setting a priority level for each alternative route, based on the result of the computation of the corresponding standard route; and
selecting, for each relay device, a particular alternative route from among alternative routes having said each relay device as a constituent element, based on the priority level which has been set.

18. A non-transitory computer readable medium storing a program for a computer to manage a network including a plurality of standard routes and a plurality of alternative routes, the plurality of standard routes each being a relay route having, as constituent elements, two or more relay devices, the plurality of alternative routes each being established for a corresponding standard route and being a relay route having, as constituent elements, two or more relay devices, a combination of which being different from a combination of the relay devices of the corresponding standard route, the program causing the computer to execute:
a priority level setting process of analyzing, for each alternative route, an amount of relayed packets per unit time in the corresponding standard route, performing a computation for each standard route using a priority level which is specified in advance for each standard route and an amount of relayed packets per unit time in each standard route, and setting a priority level for each alternative route, based on the result of the computation of the corresponding standard route; and
an alternative route selecting process of selecting, for each relay device, a particular alternative route from among alternative routes having said each relay device as a constituent element, based on the priority level set by the priority level setting process.
